(19) United States
(12) Patent Application Publication
(10) Pub. No.: US 2007/0269672 A1
(43) Pub. Date: Nov. 22, 2007

(54) Die for molding and molded product

(76) Inventor: Hiroaki Hirao, Ome-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/801,629

(22) Filed: May 9, 2007

(30) Foreign Application Priority Data
May 22, 2006 (JP) 2006-141988

(51) Int. Cl. B32B 9/04; B29C 45/00

(52) U.S. Cl. 428/543; 425/542; 425/467

(57) ABSTRACT

According to one embodiment, a die for molding a molded product including an opening is provided with (i) die surfaces which form a first space and a second space in the die, the first space corresponding to a contour of the molded product and into which molten material is poured, the second space corresponding to the opening of the molded product and communicating with the first space and in which a molten-material bridge piece is formed, and (ii) a projection which projects into the second space from one of the die surfaces and extends along a direction of flow of molten material.

### CROSS-REFERENCE TO RELATED APPLICATIONS

This application is based upon and claims the benefit of priority from Japanese Patent Application No. 2006-141988, filed May 22, 2006, the entire contents of which are incorporated herein by reference.

### BACKGROUND

1. Field

Embodiments of the invention relate to dies for molding and molded products manufactured by using the dies, for example, to a die for forming a molten-material bridge piece in an opening of a molded product and a molded product manufactured from an intermediate molded product including a molten-material bridge piece.

2. Description of the Related Art

An example of a case of an electronic apparatus, such as a portable computer, is molded by casting a magnesium alloy or some other metallic material. Specifically, a desired product shape can be obtained by feeding molten material into an internal space (so-called cavity) in a die under pressure.

A manufacturing method for a metallic case with reduced thickness and weight is described in Jpn. Pat. Appln. KOKAI Publication No. 2001-334356. Projections are provided on the inner surface which defines a cavity of the die described in this document. Recesses corresponding to the projections are formed in the metallic case that is molded by using the die. The stiffness and strength of the metallic case are enhanced by ribs that are virtually formed by a difference in level between the recesses and the back surface of the case.

The case of an electronic apparatus has various openings that are designed for a user's access to some parts in the case and for maintenance. In casting this case having the openings, the flow of molten material is disturbed around the openings. Accordingly, there may possibly be caused casting defects, such as visual defects called molten-material wrinkles on the downstream region of the openings or shape defects that are attributable to insufficient filling.

The projections of the die described in the aforesaid document, for example, are formed so that their longitudinal direction extends along the direction of flow of molten material so they will not interrupt the flow of molten material. However, the projections have a size suited for the reduction in weight of the case. Even if these projections extend along the direction of flow of molten material, there is a possibility of their disturbing the flow of molten material.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the invention;

FIG. 2 is an exemplary perspective view of a case base according to the first embodiment;

FIG. 3 is an exemplary sectional view of the case base taken along line F3-F3 of FIG. 2;

FIG. 4 is an exemplary perspective view of an intermediate molded product according to the first embodiment;

FIG. 5 is an exemplary sectional view of the intermediate molded product taken along line F5-F5 of FIG. 4;

FIG. 6 is an exemplary sectional view typically showing a die casting machine according to the first embodiment;

FIG. 7 is an exemplary perspective view showing a die according to the first embodiment and its surroundings;

FIG. 8 is an exemplary perspective view showing the die according to the first embodiment;

FIG. 9 is an exemplary sectional view of the die taken along line F9-F9 of FIG. 8;

FIG. 10 is an exemplary sectional view showing a state in which the die shown in FIG. 8 is filled with molten material;

FIG. 11 is an exemplary graph showing an effect according to the first embodiment of the invention;

FIG. 12 is an exemplary sectional view of a case base according to a second embodiment of the invention;

FIG. 13 is an exemplary sectional view of the case base taken along line F13-F13 of FIG. 12;

FIG. 14 is an exemplary sectional view showing an intermediate molded product and a die according to the second embodiment; and

FIG. 15 is an exemplary sectional view of the die taken along line F15-F15 of FIG. 14.

### DETAILED DESCRIPTION

Various embodiments according to the invention will be described hereinafter with reference to the accompanying drawings. In general, according to one embodiment of the invention, a die for molding a molded product including an opening is provided with die surfaces and a projection. The die surfaces form a first space and a second space in the die, the first space corresponding to a contour of the molded product and into which molten material is poured, the second space corresponding to the opening of the molded product and communicating with the first space and in which a molten-material bridge piece is formed. The projection projects into the second space from one of the die surfaces and extends along a direction of flow of molten material.

According to another embodiment of the invention, a molded product including an opening is manufactured by molding an intermediate molded product including a region which is formed into the opening in a later process, a molten-material bridge piece in the region, and a slit which is formed in the region so as to extend along a direction of flow of molten material, and separating the molten-material bridge piece from the intermediate molded product.

Embodiments of the present invention applied to a molded product that constitutes a part of a case of a portable computer and a die for manufacturing the molded product will now be described with reference to the accompanying drawings.

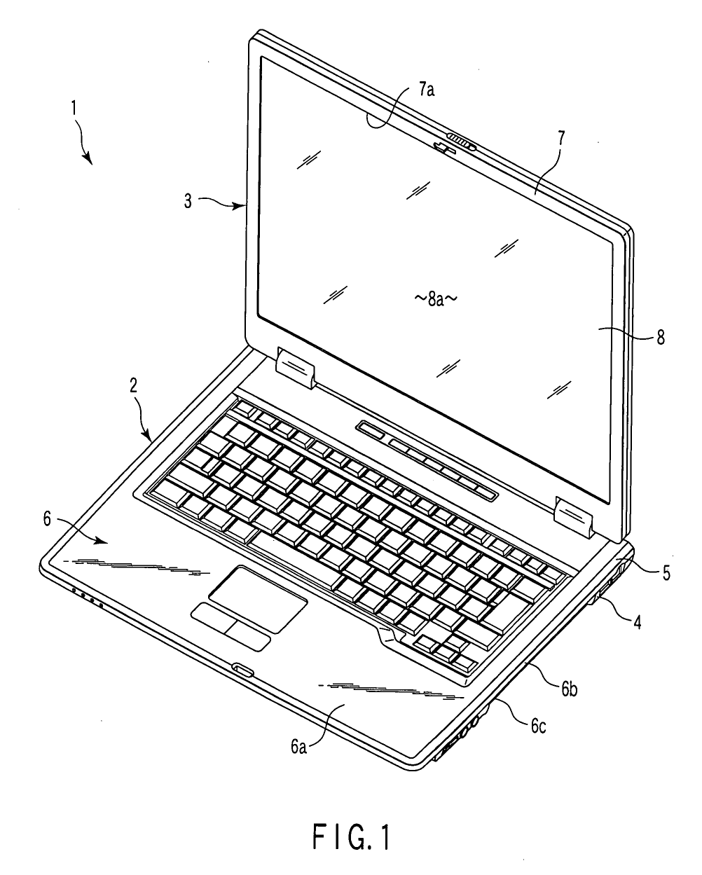

FIG. 1 shows a portable computer 1 as an electronic apparatus according to a first embodiment of the invention. As shown in FIG. 1, the portable computer 1 includes a body 2 and a display unit 3.

The body 2 includes a case base 4 and a case cover 5. The cover 5 is combined with the base 4 from above. The body 2 is provided with a box-shaped case 6 formed of the base 4 and the cover 5 that are joined together. The case 6 has a top wall 6a, a peripheral wall 6b, and a bottom wall 6c.

The display unit 3 includes a display housing 7 and a liquid crystal panel 8 contained in the housing 7. The display panel 8 has a display screen 8a. The screen 8a is exposed to the outside of the display housing 7 through an opening 7a in the front face of the housing 7.

The display unit 3 is supported on the rear end portion of the case 6 by a hinge device. Thus, the display unit 3 is swingable between a closed position in which it is brought down to cover the top wall 6a from above and an open position in which it rises to allow the top wall 6a to be exposed.

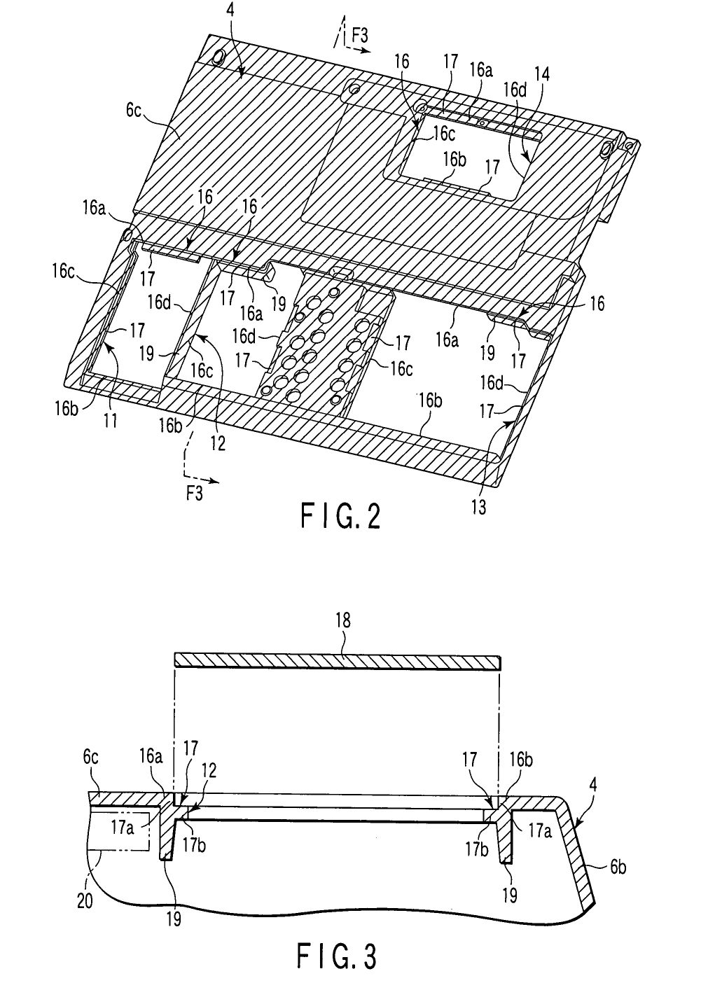

The case base 4 will now be described in detail with reference to FIGS. 2 and 3.

The case base 4 is an example of a molded product as stated in the present invention. It is formed of a magnesium alloy, for example. An example of the basic thickness of the case base 4 is 0.55 mm. However, the basic thickness of the molded product to which the invention is applicable is not limited to this value. The “basic thickness” is a thickness that is shared by a large part of the molded product. One example of the “basic thickness” is a thickness that is shared by a large part of the bottom wall 6c.

As shown in FIG. 2, the case base 4 has, for example, a plurality of rectangular openings 11, 12, 13 and 14. When viewed from the underside of the base 4, the first opening 11 opens in a left-front region of the base 4. The second opening 12 is located adjacent to the right-hand side of the first opening 11. The third opening 13 opens in a right-front region of the base 4. The fourth opening 14 opens in a rear region of the base 4.

The first to fourth openings 11 to 14 have their respective peripheral rims 16 that individually surround them. Each peripheral rim 16 is an example of an edge portion of each of the openings 11 to 14. Each rim 16 has two transverse rims 16a and 16b that extend along the longitudinal direction of the case base 4 and two lengthwise rims 16c and 16d that extend at right angles to the transverse rims 16a and 16b, for example.

The second opening 12 will now be described in detail as a representative example. As shown in FIG. 3, step portions 17 are provided on the edge portion of the opening 12. Each step portion 17 has a peripheral wall 17a that defines the inner peripheral surface of the opening 12 and a support wall 17b that extends from under the peripheral wall 17a toward the inside of the opening 12. Specifically, the step portion 17 is in the form of a so-called crank. A lid 18 is placed on the support wall 17b. The wall 17b supports the lid 18 thereon.

The case base 4 further has ribs 19 that extend from the edge portion of the second opening 12 toward the inside of the case 6. The ribs 19 reinforce the edge portion of the opening 12 and serve as blindfold ribs that conceal, for example, a unit 20 in the case 6 from a user's eyes.

Each of the first, third, and fourth openings 11, 13 and 14 has step portions 17 and ribs 19 that are similar to those of the second opening 12. However, the step portions 17 and the ribs 19 need not be formed covering the entire circumference of the peripheral rims 16 but may be formed only partially. The step portions 17 and/or the ribs 19 may be omitted.

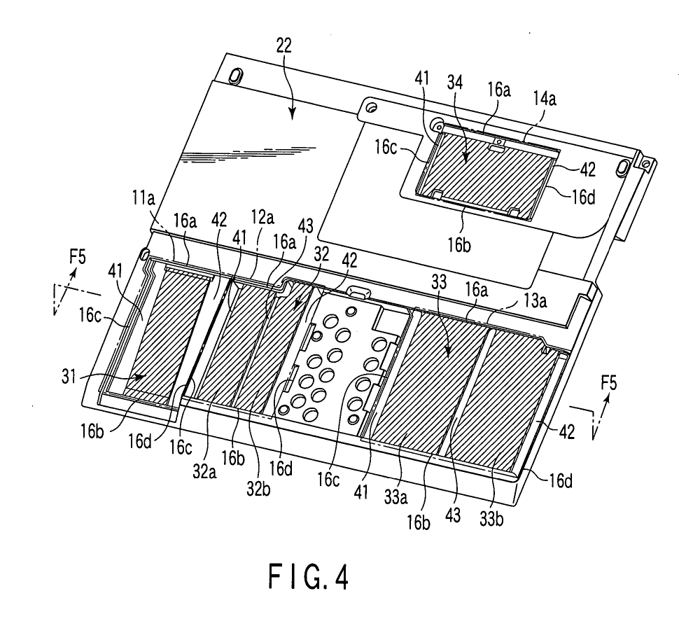

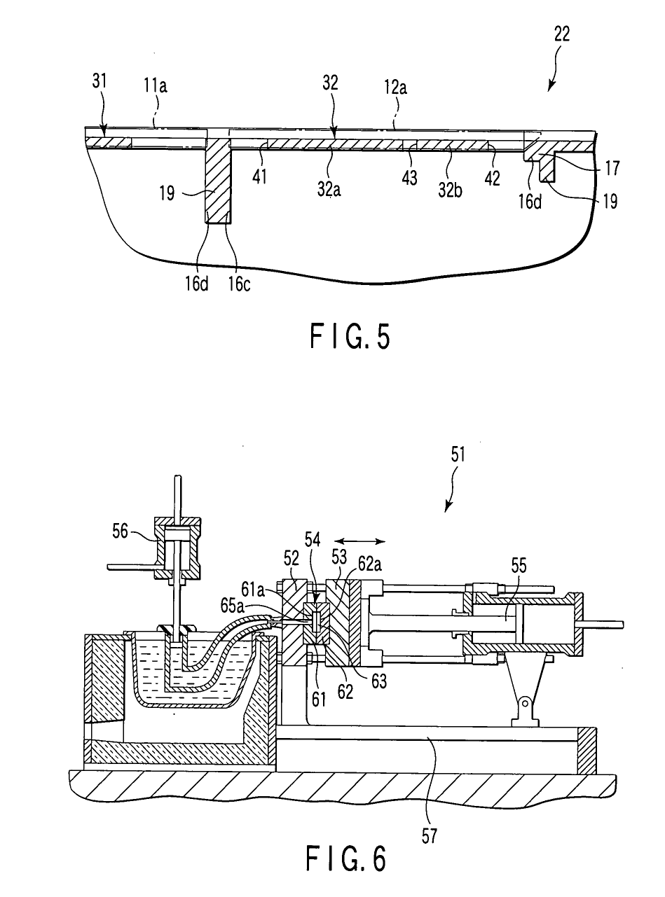

An intermediate molded product 22 that is used as a source for the manufacture of the case base 4 will now be described with reference to FIGS. 4 and 5.

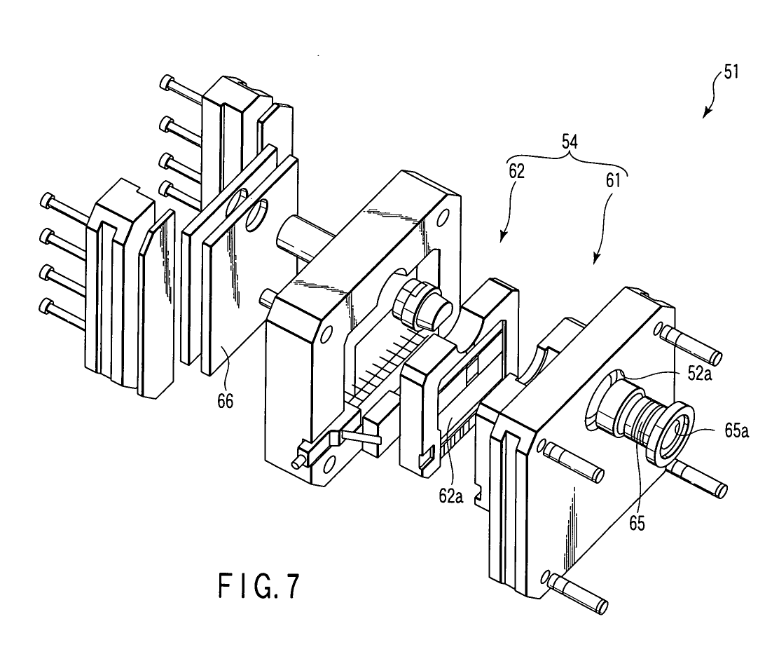

The intermediate molded product 22 is an example of a cast product produced by using a die shown in FIG. 7. It has first, second, third, and fourth regions 11a, 12a, 13a and 14a that are formed into the openings 11, 12, 13 and 14, respectively, of the case base 4 in a later process. For example, the first region 11a is formed into the first opening 11 by, for example, pressing in the later process.

As shown in FIG. 4, first, second, third, and fourth molten-material bridge pieces 31, 32, 33 and 34 (hatched portions in FIG. 4) are formed in the first, second, third, and fourth regions 11a, 12a, 13a and 14a, respectively. For example, the first molten-material bridge piece 31 is provided in the first region 11a. Likewise, the second, third, and fourth molten-material bridge pieces 32, 33 and 34 are formed in the second, third, and fourth regions 12a, 13a and 14a, respectively.

The “molten-material bridge piece” is a lumber portion that covers an opening of a molded product. If an attempt is made directly to cast a molded product having openings without changing its shape, the flow of molten material is disturbed around the openings, so that casting defects may possibly be caused on the downstream region of the openings. In the present embodiment, therefore, an intermediate molded product having covered openings is molded by casting, and a molded product with a desired shape is obtained by removing the covered portions by pressing or the like in a later process. The “molten-material bridge piece” described herein is a lumber portion that covers each opening and forms a runner.

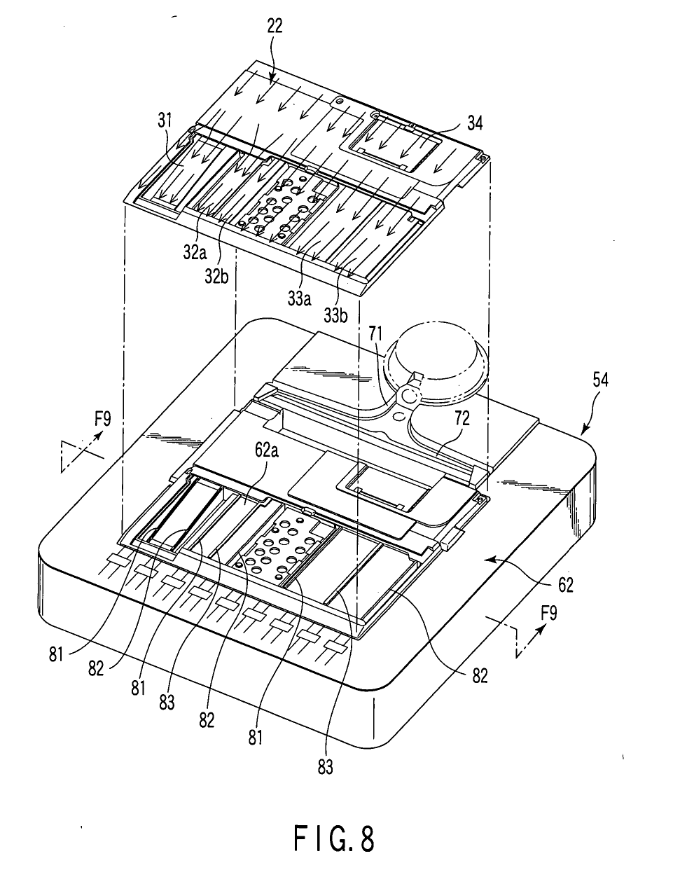

The intermediate molded product 22 is formed by running molten material in the direction of arrows in FIG. 8. Specifically, the transverse rims 16a and 16b of the first to fourth openings 11 to 14 extend at right angles to the direction of flow of molten material. The lengthwise rims 16c and 16d extend parallel to the direction of flow of molten material.

The second region 12a will now be described in detail as a representative example. Like numerals are used to designate those configurations of the first, third, and fourth regions 11a, 13a and 14a which have the same functions as those of the second region 12a, and a description thereof is omitted.

As shown in FIG. 4, the second molten-material bridge piece 32 is formed in the second region 12a. The second bridge piece 32 is provided between the two transverse rims 16a and 16b. A first slit 41 is formed on the left-hand side of the second molten-material bridge piece 32 as in FIG. 4. It extends along one edge of the opening 12 that extends along the direction of flow of molten material. A second slit 42 is formed on the right-hand side of the second bridge piece 32. It extends along the other edge of the opening 12 that extends along the direction of flow of molten material. A third slit 43 is formed substantially in the center of the second bridge piece 32.

The first to third slits 41 to 43 extend along the direction of flow of molten material. They are provided between the two transverse rims 16a and 16b. Each of the slits 41 to 43 has an elongated shape such that its length is greater than its width. As shown in FIG. 5, the first to third sits 41 to 43 penetrate the intermediate molded product 22.

The first slit 41 separates the second molten-material bridge piece 32 from the one lengthwise rim 16c of the second opening 12. The second slit 42 separates the second molten-material bridge piece 32 from the other lengthwise rim 16d of the second opening 12. The third slit 43 divides the second bridge piece 32 into two independent molten-material bridge pieces 32a and 32b.

Likewise, the third molten-material bridge piece 33 is divided into two independent molten-material bridge pieces 33a and 33b by the third slit 43.

As described above, the molten-material bridge pieces 31 to 34 of the present embodiment are not provided for all the regions 11a to 14a. In the case of the second region 12a, for example, the one opening 12 is formed having the two independent molten-material bridge pieces 32a and 32b that are separated from the lengthwise rims 16c and 16d of the opening 12. The first and second slits 41 and 42 are wider than the third slit 43.

A manufacturing apparatus for casting the intermediate molded product 22 will now be described with reference to FIGS. 6 to 10. FIG. 6 shows a die casting machine 51 as an example of the manufacturing apparatus. The die casting machine 51 includes a stationary platen 52, movable platen 53, die 54, die clamping mechanism 55, and molten-material pouring mechanism 56. The stationary platen 52 is fixed on a frame 57 that is set in place. The movable platen 53 faces the stationary platen 52 and is movable toward and away from the stationary platen 52.

The die 54 is provided with a stationary die 61 (so-called die cavity) and a movable die 62 (so-called die core). Thus, a “die” as stated in the present invention is a die set that includes a stationary die and a movable die.

The stationary die 61 forms an obverse side of a product, for example. The stationary die 61 is fixed to the stationary platen 52. The movable die 62 forms a reverse side of the product, for example. The movable die 62 is fixed to the movable platen 53. The movable die 62 is movable following the movable platen 53 toward the stationary die 61.

The stationary die 61 has a first die surface 61a that faces the movable die 62. The first die surface 61a is depressed corresponding to the external shape of the obverse side of the intermediate molded product 22. The movable die 62 has a second die surface 62a that faces the stationary die 61. The second die surface 62a is depressed corresponding to the external shape of the reverse side of the intermediate molded product 22.

When the stationary and movable dies 61 and 62 are clamped together, the first and second die surfaces 61a and 62a come into contact with each other. When the first and second die surfaces 61a and 62a touch each other, an internal space 63 (so-called cavity) that is shaped corresponding to the intermediate molded product 22 is formed between the die surfaces 61a and 62a. In other words, the first and second die surfaces 61a and 62a form the internal space 63.

An example of the die clamping mechanism 55 is a hydraulic cylinder. The die clamping mechanism 55 is connected to the movable platen 53 and clamps the die 54 by moving the movable platen 53. The molten-material pouring mechanism 56 has, for example, a plunger and a pressure cylinder, which feeds molten material into the internal space 63 of the die 54 under pressure. An example of molten material according to the present embodiment is a molten metal prepared by melting a magnesium alloy.

FIG. 7 shows the die 54 of the die casting machine 51 and its surroundings in detail.

The stationary die 61 is provided with an opening 52a. A molten-material pouring pipe 65 is mounted through the opening 52a. A casting port 65a (so-called sprue) opens in the pouring pipe 65. It allows the molten-material pouring mechanism 56 to communicate with the internal space 63 of the die 54. An ejector plate 66 is located behind the movable die 62. The ejector plate 66 is provided with so-called ejector pins.

FIG. 8 shows details of the movable die 62.

A cylindrical portion (not shown) called a biscuit is formed in the most upstream region in the die 54. A gate 72 communicates with this biscuit by means of a runner 71. The gate 72 is in the form of a fin that spreads so that its width approaches downstream to the transverse width of the case base 4. The gate 72 corresponds to the rear end side of the base 4. Specifically, molten material that is introduced into the internal space 63 through the gate 72 flows from the rear end portion of the intermediate molded product 22 toward the front end portion (see arrows in FIG. 8).

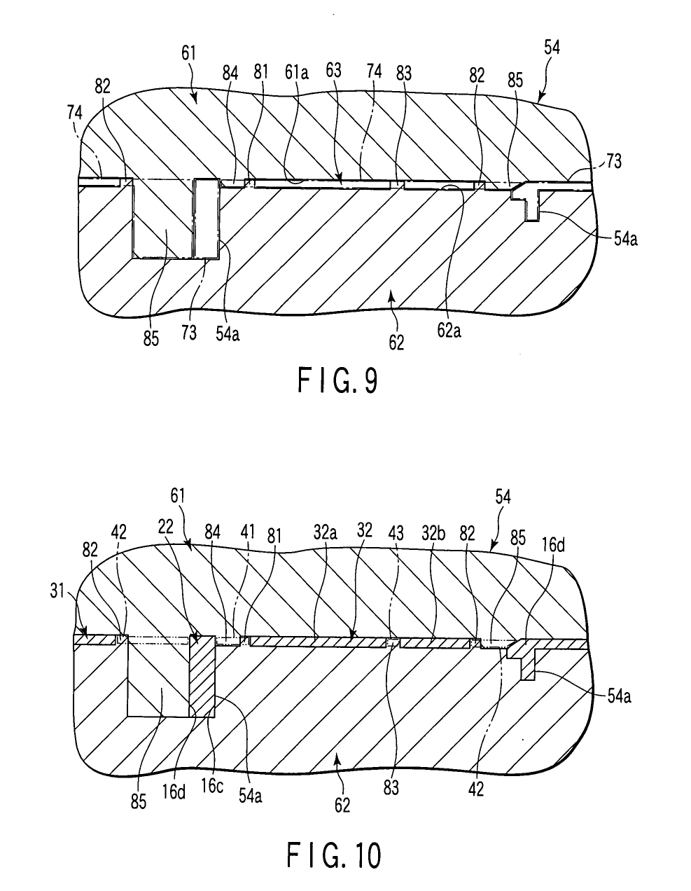

As shown in FIG. 9, the internal space 63 of the die 54 includes a first space 73 and a second space 74. The first space 73 corresponds to the external shape of the case base 4. In other words, the first space 73 has the same shape as the contour of the base 4.

The second space 74 is a space for the formation of a molten-material bridge piece. Specifically, the second space 74 is provided corresponding to the regions (i.e., first to fourth regions 11a to 14a) that are expected to form the first to fourth openings 11 to 14 of the case base 4, individually. More specifically, the second space 74 that corresponds to the second opening 12, for example, is configured to form the second molten-material bridge piece 32 and the first to third slits 41 to 43.

The second space 74 is located inside the respective peripheral rims 16 of the first to fourth openings 11 to 14. It communicates with the first space 73. Thus, molten material that is poured into the first space 73 also fills the second space 74.

As shown in FIGS. 8 and 9, the stationary die 61 and the movable die 62 have projections on the first and second die surfaces 61a and 62a thereof. The projections corresponding to the second opening 12 will now be described in detail as a representative example. The first, third, and fourth openings 11, 13 and 14 have substantially the same projections.

As shown in FIG. 8, the movable die 62 has first, second, and third projections 81, 82 and 83. The first projection 81 corresponds to a part of the first slit 41 of the intermediate molded product 22. The second projection 82 corresponds to a part of the second slit 42. The third projection 83 corresponds to the third slit 43.

The first to third projections 81 to 83 are arranged along the direction of flow of molten material so as to be stretched between the two transverse rims 16a and 16b of the second opening 12. As shown in FIG. 9, the first to third projections 81 to 83 individually project into the second space 74 from the second die surface 62a that faces the space 74. Respective projected ends of the projections 81 to 83 are in contact with the first die surface 61a.

On the other hand, the stationary die 61 has fourth and fifth projections 84 and 85. The fourth projection 84 corresponds to a part of the first slit 41. The fifth projection 85 corresponds to a part of the second slit 42. The fourth and fifth projections 84 and 85 are arranged along the direction of flow of molten material so as to be stretched between the two transverse rims 16a and 16b of the second opening 12.

The fourth and fifth projections 84 and 85 individually project into the second space 74 from the first die surface 61a that faces the space 74. Respective projected ends of the projections 84 and 85 are in contact with the second die surface 62a. Under the presence of the first to fifth projections 81 to 85, the second space 74 is formed into a hollow space that has substantially the same external shape as the second molten-material bridge piece 32.

As shown in FIG. 10, the first slit 41 is formed in a manner such that the region in which the first and fourth projections 81 and 84 exist is not filled with molten material. Likewise, the second slit 42 is formed in a manner such that the region in which the second and fifth projections 82 and 85 exist is not filled with molten material. The third slit 43 is formed in a manner such that the region in which the third projection 83 exists is not filled with molten material.

The following is a description of the operation of the die 54.

The stationary die 61 and the movable die 62 are clamped together, and molten material is forced into the casting port 65a. Molten material introduced through the casting port 65a is first supplied to the biscuit and then guided into the internal space 63 of the die 54 through the runner 71 and the gate 72 that connect with the biscuit. The contour of the case base 4 is defined as the first space 73 of the internal space 63 is filled with molten material. The flow of molten material that runs through the first space 73 of the internal space 63 is disturbed around the first to fourth openings 12 to 14.

More specifically, the step portions 17, the ribs 19, etc., which are situated on the upstream region of the openings 11 to 14, disturb the flow of molten material. Molten material is forced to change its direction of flow when it is filled into the step portions 17, for example, so that its flow is disturbed. When molten material is filled into the ribs 19, for example, it pushes out air from channels 54a which is provided in the die 54 to form the ribs 19. The air pushed out in this manner collides with molten material behind it, thereby disturbing the flow of the material.

Molten material that is disturbed on the upstream region of the openings 11 to 14 is kept disturbed as it flows into the second space 74 in which the molten-material bridge pieces 31 to 34 are formed. Molten material poured into the second space 74 forms the bridge pieces 31 to 34 and its flow is rectified as it passes through the second space 74. Specifically, molten material can be adjusted to its original direction of flow as it flows along the projections 81 to 85. Thus, disturbance of the flow caused on the upstream region of the openings 11 to 14 can be regulated.

The cross section of the intermediate molded product 22 along a direction perpendicular to the flow of molten material becomes smaller at the openings 11 to 14. Therefore, the flow area of molten material is reduced, so that the flow of molten material is accelerated. As the flow of molten material is thus accelerated, its directivity is enhanced. There are also some disturbing elements, such as the step portions 17 and the ribs 19, on the downstream region of the openings 11 to 14. Since the flow of molten material according to the present embodiment has high directivity, however, molten material can be filled into the step portions 17 and the ribs 19 and further flow downward without being greatly disturbed.

The flow area increases again on the downstream region of the openings 11 to 14. However, the flow of molten material is accelerated during the passage through the molten-material bridge pieces 31 to 34. Thus, molten material can also be filled into the front end portion of the intermediate molded product 22 at the most downstream end portion without being greatly stalled.

The case base 4 can be obtained by separating, by pressing, for example, the first to fourth molten-material bridge pieces 31 to 34 from the intermediate molded product 22 that is cast in the aforesaid manner.

According to the die 54 and the molded product 4 constructed in this manner, the flow of molten material can be regulated to suppress casting defects. Thus, if an attempt is made to cast the molded product 4 that has the openings 11 to 14, the flow of molten material is disturbed around the openings 11 to 14.

If the molten-material bridge pieces 31 to 34 are formed in the second space 74 into which the projections 81 to 85 project, however, molten material disturbed on the upstream region of the openings 11 to 14 is rectified by the projections 81 to 85 as guides. Thus, the disturbance caused on the upstream region of the openings 11 to 14 can be reduced.

Further, the projections 81 to 85 serve to reduce the flow area around the openings 11 to 14. Accordingly, molten material is accelerated, so that the directivity of the flow is enhanced. Thus, disturbance of the flow on the downstream region of the openings 11 to 14 is suppressed.

In order to improve the flow of molten material, it may apparently be desirable to secure a generous cross section for the runner without providing the projections 81 to 85 that project into the second space 74. In the present embodiment, however, the projections 81 to 85 are positively provided so that the cross section of the runner is reduced to a suitable size, whereby the flow of molten material can be accelerated. Thus, the directivity of the flow of molten material is enhanced, so that the disturbance of the flow on the downstream region of the openings 11 to 14 can be suppressed.

If the flow of molten material is regulated in this manner, external defects, such as molten-material wrinkles, are reduced. If the flow of molten material is regulated, moreover, a deficiency in the amount of molten material at the downstream end portion can be suppressed, so that shape defects, such as short shots, are reduced.

Although a rectifying effect can be obtained if the projections 81 to 85 are provided in the first space 73, for example, recesses corresponding to the projections 81 to 85 are inevitably formed in the case base 4. If the projections 81 to 85 are provided in the second space 74 in which the molten-material bridge pieces 31 to 34 are formed, on the other hand, the molten material rectifying effect can be obtained without changing the external shape of the case base 4.

The rectifying effect can be further enhanced if the projections 81 to 85 define the slits 41 and 43 in the intermediate molded product 22, in particular. Thus, if the intermediate molded product 22 has the slits 41 to 43, molten material cannot flow into or out of regions that adjoin one another with the slits 41 to 43 between them. More specifically, molten material is restrained from flowing across its original direction of flow, so that the molten material rectifying effect can be additionally enhanced.

If the slits 41 and 42 are provided along edges of the openings 11 to 14, for example, the molten material rectifying effect can be further enhanced. Thus, if the molten-material bridge pieces 31 to 34 are separated from the edges of the opening 11 to 14, molten material that flows through the bridge pieces 31 to 34 and molten material that flows in the base 4 hardly interfere with each other, and they are rectified individually.

If the slits 41 and 42 are formed along edges of the openings 11 to 14, molten material never flows across the step portions 17 or the ribs 19 that are arranged along the lengthwise rims 16c and 16d of the openings 11 to 14. Thus, disturbance of the flow of molten material can be suppressed.

In the present embodiment, the first and second slits 41 and 42 are wider than the third slit 43. Thus, the molten-material bridge pieces 31 to 34 can be removed by pressing with improved ease.

If the slit 43 is provided substantially in the center of each of the molten-material bridge pieces 32 and 33, for example, the rectifying effect for the molten material is further enhanced. Specifically, the bridge pieces 32 and 33 are divided into the independent molten-material bridge pieces 32a, 32b, 33a and 33d, so that two flows that never interfere with each other can be created in the bridge pieces 32 and 33. Thus, the molten material can be rectified.

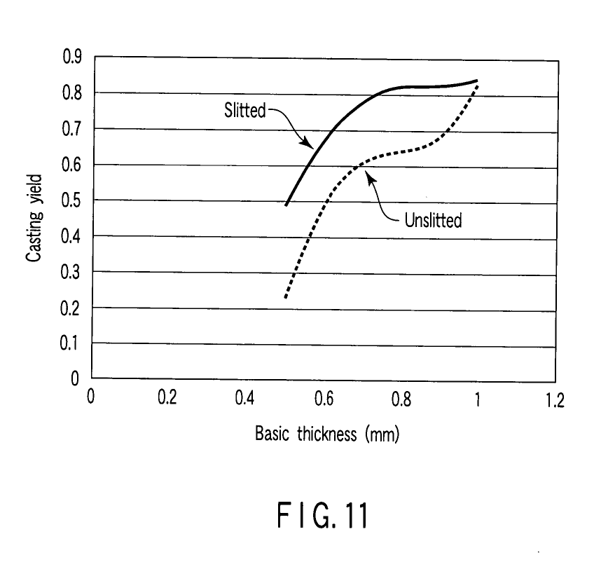

FIG. 11 shows an example of an experimental result that demonstrates the effect of the formation of the slits 41 to 43. In FIG. 11, the abscissa axis represents the basic thickness of the case base as the molded product, and the ordinate axis represents the casting yield of the case base. The “casting yield” is the ratio, to a plurality of test samples, of intermediate molded products that can be delivered to subsequent processes without any casting defects of a significant level. In the diagram, “unslitted” indicates the casting state of case bases without slits 41, 42, 43; “slitted” indicates the casting state of the case base 4 that is formed having slits in the openings according to the present embodiment.

More specifically, each case base used in the experiment is a case base of a so-called A4-size notebook PC that externally measures about 290 mm (length)×230 mm (with). Its material component is AZ91D, an Mg—Al—Zn alloy. The calculation of the casting yield is based on a comprehensive consideration of the size and weight of castings and their external conditions, such as molten-material wrinkles, cracks, shrinkage, etc.

As shown in FIG. 11, the smaller the basic thickness of a molded product, in general, the higher the difficulty of flow of molten material is, and the lower the casting yield is. As seen from this experimental result, slitted molded products are superior to unslitted ones in casting yield.

If molded products according to the present embodiment are thin-walled structures such that the basic thickness of the case base 4 is 0.8 mm or less, their suppressing effect against casting defects can be regarded as remarkable from one point of view. In molded products such that the basic thickness of the case base 4 is nearly 1.0 mm, for example, the casting yield is not very poor even if the products are unslitted.

In the case of molded products for which the basic thickness is 0.8 mm or less, on the other hand, the casting yield is found to be improved by nearly 20% as compared with the case of unslitted molded products. Thus, the present embodiment can be regarded as particularly effective for thin-walled structures such that the basic thickness of the case base 4 is 0.8 mm or less.

If the basic thickness for unslitted products is 0.8 mm or less, for example, their casting yield is inevitably lower by nearly 20% than that of molded products for which the basic thickness is 1.0 mm. In the case of slitted products, on the other hand, lowering of the casting yield can be extensively restrained despite the basic thickness of 0.8 mm or less. Thus, the present embodiment can be regarded as effective for the range of the basic thickness of 0.8 mm or less.

If the basic thickness of the case base 4 is less than 0.5 mm, the base 4 lacks in stiffness, and the current casting technology is confronted with a limitation. Thus, it can also be said that the present embodiment can be applied particularly effectively to the basic thickness ranging from 0.5 mm to 0.8 mm. However, the lower limit value according to the embodiment of the present invention is not limited to 0.5 mm. This lower limit value is a problem that can be solved by the development of novel materials and the progress of the casting technology. The embodiment of the invention can be regarded as effective for any of thin-walled products with a basic thickness of 0.8 mm or less.

Also if the basic thickness is nearly 0.4 mm, as seen from FIG. 11, for example, a higher casting yield can be maintained in the case of slitted products than in the case of unslitted ones. Thus, it can also be said that the present embodiment can be applied particularly effectively to the basic thickness ranging from 0.4 mm to 0.8 mm.

If molded products according to the present invention are thin-walled structures such that the basic thickness of the case base 4 is 0.6 mm or less, their suppressing effect against casting defects can be regarded as remarkable from another point of view. If the basic thickness for unslitted products is 0.6 mm or less, for example, the casting yield lowers drastically. Also in the case of slitted products, on the other hand, the casting yield lowers if the basic thickness is 0.6 mm or less. In this case, however, a still high casting yield can be maintained as compared with the case of unslitted products. Thus, it can also be said that the embodiment of the present invention can be applied particularly effectively to the basic thickness within the range from 0.5 to 0.6 mm.

As mentioned before, moreover, the lower limit value according to the embodiment of the present invention is not limited to 0.5 or 0.4 mm. The embodiment of the invention can be regarded as effective for any of thin-walled products with a basic thickness of 0.6 mm or less.

The third slit 43 is not limited to one in number, and a plurality of third slits may be suitably provided corresponding to the width of each molten-material bridge piece.

A die 91 and a case base 92 as a molded product according to a second embodiment of the invention will now be described with reference to FIGS. 12 to 15. Like numerals are used to designate those configurations which have the same functions as those of the die 54 and the case base 4 according to the first embodiment, and a description thereof is omitted.

The case base 92 constitutes a part of the case 6 of the portable computer 1 by being combined with the case cover 5. As shown in FIG. 12, the case base 92 has an opening 93. In casting the case base 92, molten material is run from top to bottom in FIG. 12.

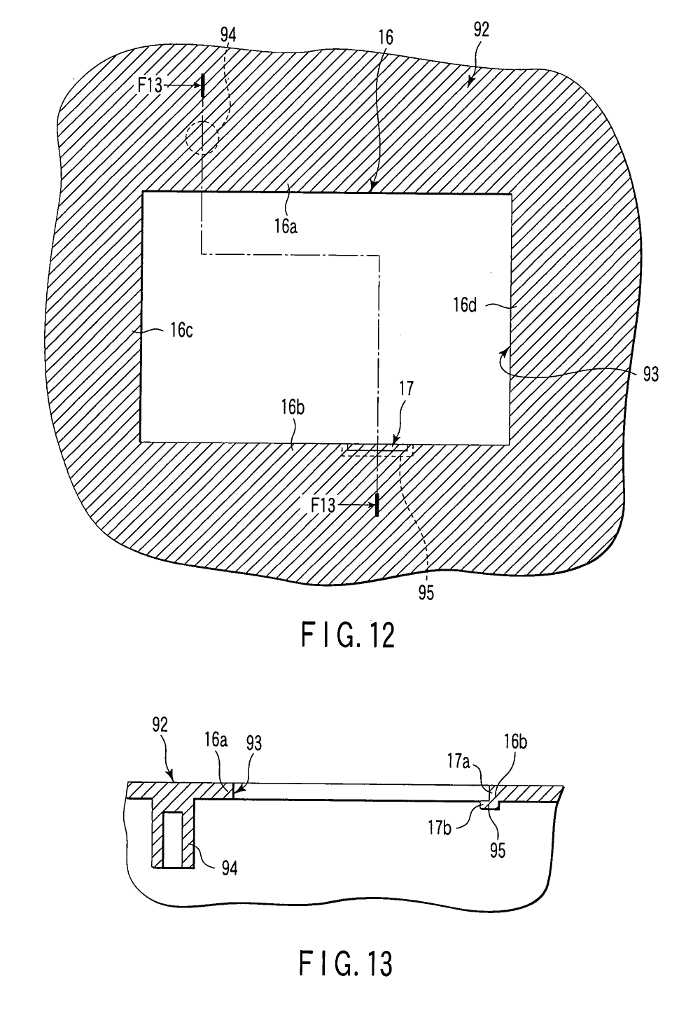

As shown in FIGS. 12 and 13, a first structure element 94 is provided on the upstream region with respect to the opening 93 along the direction of flow of molten material. An example of the structure element 94 is a boss that projects inside the case 6. A second structure element 95 is provided on the downstream region with respect to the opening 93 along the direction of flow of molten material. An example of the structure element 95 is a step portion that is provided on a part of a transverse rim of the opening 93.

The first and second structure elements 94 and 95 individually cause flow of molten material to be disturbed. They are not limited to the boss or the step portion, but the present embodiment is applicable to any other elements that disturb the flow of molten material.

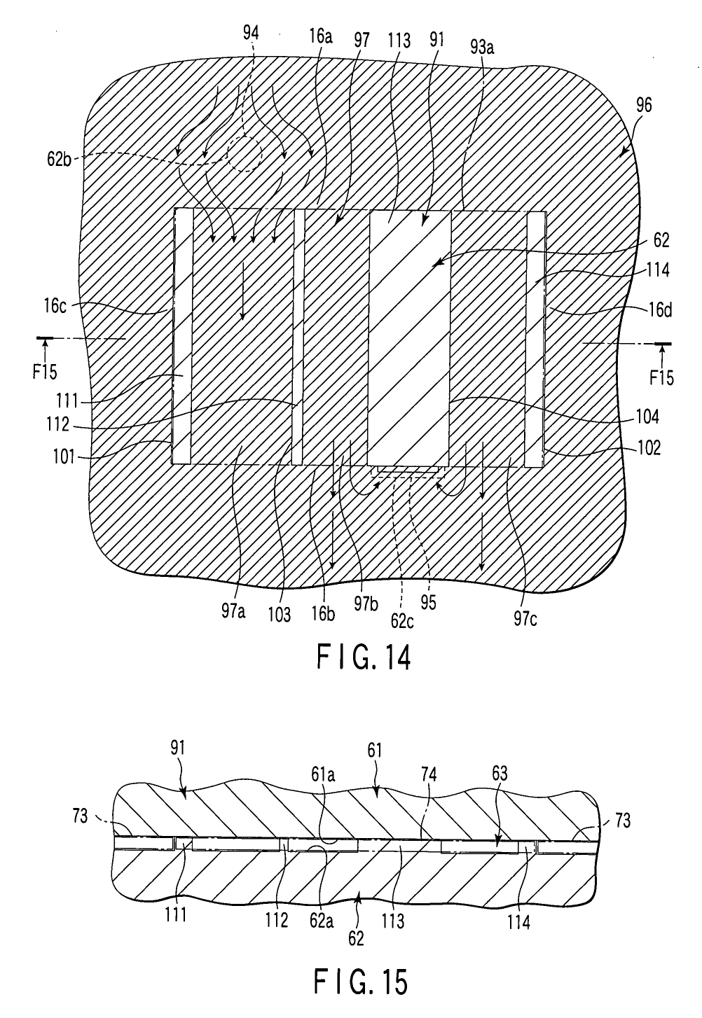

FIG. 14 shows an intermediate molded product 96 as a source for the manufacture of the case base 92. The intermediate molded product 96 has a molten-material bridge piece 97 in a region 93a that is formed into the opening 93 in a later process. The region 93a is further provided with first, second, third, and fourth slits 101, 102, 103 and 104. The first and second slits 101 and 102 are formed individually along edges of the opening 93 that extend along the direction of flow of molten material and separate the molten-material bridge piece 97 from lengthwise rims 16c and 16d of the opening 93. The third and fourth slits 103 and 104 open in the bridge piece 97 and divide the bridge piece 97 into first, second, and third independent molten-material bridge pieces 97a, 97b and 97c.

The first molten-material bridge piece 97a is formed behind the first structure element 94 along the direction of flow of molten material. In the description herein, a position “behind an object along the direction of flow of molten material” is a region at the back (i.e., on the lower side in FIG. 4) of the object being described (i.e., first structure element 94 in this case) along the direction of flow of molten material (i.e., from top to bottom in FIG. 14). Specifically, this position is on an extension of a flow line of molten material before the disturbance of the flow.

The second and third molten-material bridge pieces 97b and 97c are located off a region in front of the second structure element 95 along the direction of flow of molten material. Specifically, the slit 103 is formed so as to be situated in front of the structure element 95. In the description herein, a position “in front of an object along the direction of flow of molten material” is a region short (i.e., on the upper side in FIG. 4) of the object being described (i.e., second structure element 95 in this case) along the direction of flow of molten material.

The die 91 of a die casting machine 51 is provided with a stationary die 61 and a movable die 62 and has therein an internal space 63 that includes a first space 73 and a second space 74. The die 91 has first and second die surfaces 61a and 62a. The second die surface 62a is provided with a depression 62b in which the first structure element 94 is cast and a depression 62c in which the second structure element 95 is cast.

As shown in FIG. 15, first, second, third, and fourth projections 111, 112, 113 and 114 protrude from the second die surface 62a and project into the second space 74. The first to fourth projections 111 to 114, which project into the second space 74, have their respective projected ends in contact with the first die surface 61a. The projections 111 to 114 extend along the direction of flow of molten material. They are stretched between two transverse rims 16a and 16b. The first projection 111 forms the first slit 101. Likewise, the second to fourth projections 112 to 114 form the second to fourth slits 102 to 104.

The following is a description of functions of the die 91.

As shown in FIG. 14, the flow of molten material is disturbed by the first structure element 94. The disturbed flow of molten material gets into the first molten-material bridge piece 97a and is rectified therein. Some of the molten material introduced through the second and third molten-material bridge pieces 97b and 97c rounds the second structure element 95 sideways or from behind, whereupon the element 95 is filled.

The remainder of the molten material passed through the second and third molten-material bridge pieces 97b and 97c is loaded into the front end portion of the case base 4 that corresponds to the downstream end portion of the molten material.

According to the die 91 and the case base 92 constructed in this manner, the flow of molten material can be regulated to suppress casting defects. Thus, for the same reason as that for the die 54 according to the first embodiment, a rectifying effect acts on the molten material, so that the flow of molten material can be regulated to suppress casting defects.

If the molten-material bridge piece 97a is formed behind the structure element 94 that disturbs the flow, for example, the flow disturbed by the element 94 can be drawn directly into the bridge piece 97a and rectified therein. In other words, the disturbance hardly diffuses around if the bridge piece 97a is located behind the region where the flow is easily disturbed so that the disturbed flow can be intensively drawn in and rectified. Thus, casting defects can be suppressed further.

If the molten-material bridge pieces 97b and 97c are formed without interfering with the region in front of the structure element 95 that disturbs the flow, for example, molten material passed through the bridge pieces 97b and 97c cannot be easily disturbed by the structure element 95. Thus, molten material can further flow toward the downstream end portion without failing to suppress the disturbance, so that casting defects can be suppressed.

Although the dies 54 and 91 and the molded products 4 and 92 according to the first and second embodiments have been described herein, the present invention is not limited to these embodiments. For example, the molten material is not limited to a magnesium alloy but may be any other material. Each of the first and second slits 41 and 42 need not always be wider than the third slit 43. Projections 81, 82, 83, 84, 85, 111, 112, 113, 114 do not necessarily need to be as large as they make slits 41, 42, 43, 101, 102, 103, 104, if there is the rectification effect. The form of projections 81, 82, 83, 84, 85, 111, 112, 113, 114 are not limited. The intermediate molded product that is cast in the die 54 or 91 may be any other molded product than a case of a portable computer. For example, the embodiments of the present invention are not limited to die casting but may also be applied suitably to dies for any other casting or molding methods, such as thixo molding.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A die for molding a molded product which includes an opening, comprising:
die surfaces which form a first space and a second space in the die, the first space corresponding to a contour of the molded product and into which molten material is poured, the second space corresponding to the opening of the molded product and communicating with the first space and in which a molten-material bridge piece is formed; and
a projection which projects into the second space from one of the die surfaces and extends along a direction of flow of molten material.

2. A die according to claim 1, wherein the projection forms a slit in the molded product so as to extend along the direction of flow of molten material.

3. A die according to claim 2, wherein the slit is formed along an edge of the opening of the molded product along the direction of flow of molten material and separates the molten-material bridge piece from the edge.

4. A die according to claim 2, wherein the slit is formed in the molten-material bridge piece and divides the bridge piece into a plurality of independent molten-material bridge pieces.

5. A die according to claim 4, wherein the molded product includes a structure element which is located on an upstream region of molten material with respect to the opening and disturbs flow of molten material, and one of the plurality of molten-material bridge pieces is formed behind the structure element along the direction of flow of molten material.

6. A die according to claim 4, wherein the molded product includes a structure element which is located on a downstream region of the molten material with respect to the opening and disturbs flow of molten material, and the plurality of molten-material bridge pieces are formed off a region in front of the structure element along the direction of flow of molten material.

7. A die according to claim 1, wherein the molded product has a basic thickness of 0.8 mm or less.

8. A die for molding an intermediate molded product, the intermediate molded product including a region which is formed into an opening in a later process, a molten-material bridge piece in the region, and a slit which is formed in the region so as to extend along a direction of flow of molten material.

9. A die according to claim 8, wherein the slit separates the molten-material bridge piece from an edge of the opening along the direction of flow of molten material.

10. A die according to claim 8, wherein the slit is formed in the molten-material bridge piece and divides the bridge piece into a plurality of independent molten-material bridge pieces.

11. A molded product including an opening, the molded product manufactured by
molding an intermediate molded product including a region which is formed into the opening in a later process, a molten-material bridge piece in the region, and a slit which is formed in the region so as to extend along a direction of flow of molten material; and
separating the molten-material bridge piece from the intermediate molded product.

12. A molded product according to claim 11, wherein the slit is formed by a projection which is provided on a die surface of a die for molding the intermediate molded product.

13. A molded product according to claim 11, wherein the slit is formed along an edge of the opening of the molded product along the direction of flow of molten material.

14. A molded product according to claim 11, wherein the slit is formed in the molten-material bridge piece and divides the bridge piece into a plurality of independent molten-material bridge pieces.

15. A molded product according to claim 14, wherein the molded product includes a structure element which is located on an upstream region of the molten material with respect to the opening and disturbs flow of molten material, and one of the plurality of molten-material bridge pieces is formed behind the structure element along the direction of flow of molten material.

16. A molded product according to claim 14, wherein the molded product includes a structure element which is located on a downstream region of the molten material with respect to the opening and disturbs flow of molten material, and the plurality of molten-material bridge pieces are formed off a region in front of the structure element along the direction of flow of molten material.

17. A molded product according to claim 11, wherein the molded product has a basic thickness of 0.8 mm or less.
